(19) United States
(12) Patent Application Publication
(10) Pub. No.: US 2025/0231792 A1
(43) Pub. Date: Jul. 17, 2025

(54) INTERRUPT INFORMATION PROCESSING METHOD AND APPARATUS, DEVICE, AND STORAGE MEDIUM

(71) Applicant: Beijing Volcano Engine Technology Co., Ltd., Beijing (CN)

(72) Inventor: Zhimin FENG, Beijing (CN)

(21) Appl. No.: 18/908,418

(22) Filed: Oct. 7, 2024

(30) Foreign Application Priority Data
Jan. 17, 2024 (CN) 202410068507.4

(51) Int. Cl. G06F 9/48; G06F 9/455

(52) U.S. Cl. CPC G06F 9/4812; G06F 9/45558; G06F 2009/45575

(57) ABSTRACT

Embodiments of the present disclosure provide an interrupt information processing method and apparatus, a device, and a storage medium. The method includes: in response to a VCPU process switching from being in a running state to being in a wait-to-run state, obtaining interrupt attribute information corresponding to the VCPU process, where the interrupt attribute information includes interrupt type information and interrupt status information; adjusting the interrupt type information in the interrupt attribute information to preset interrupt information, and adjusting the interrupt status information in the interrupt attribute information to a receivable state; and in response to receiving an interrupt injection instruction for the VCPU process, sending the preset interrupt information to a target PCPU where the VCPU process is located, executing, through the target PCPU, a preset callback function associated with the preset interrupt information to adjust the VCPU process in the wait-to-run state to be in the running state.

### CROSS-REFERENCE TO RELATED APPLICATIONS

This application claims priority to Chinese Patent Application No. 202410068507.4, filed on Jan. 17, 2024, which is hereby incorporated by reference in its entirety.

### TECHNICAL FIELD

Embodiments of the present disclosure relate to the field of virtual machine technologies, and in particular, to an interrupt information processing method and apparatus, a device, and a storage medium.

### BACKGROUND

In order to improve resource utilization of a CPU (Central Processing Unit), the CPU may be divided into a plurality of physical central processing unit s (PCPUs), and a plurality of virtual machines may be created in the CPU. Each virtual machine may be provided with a plurality of VCPUs (Virtual Central Processing Unit) processes, and one virtual machine may occupy one PCPU to process a specific VCPU process in the virtual machine.

In the related art, when a specific task needs to be processed, an interrupt may be injected into a VCPU process corresponding to the task, and the task is processed by running the VCPU process. Currently, the interrupt is generally injected into the VCPU process by using an IOMMU (Input/Output Memory Management Unit). The interrupt may be injected into the VCPU process only when the VCPU process is in a running state.

However, the inventors have found that the related art has at least the following technical problems: if the VCPU process is in a wait-to-run state, the VCPU process needs to wait for task processing of other process to be completed, the VCPU process can be run, and then the interrupt is injected into the VCPU process. It can be seen that the interrupt injection delay by using the foregoing method is high, thereby reducing processing efficiency of interrupt information.

### SUMMARY

Embodiments of the present disclosure provide an interrupt information processing method and apparatus, a device, and a storage medium, which can reduce an interrupt injection delay of a virtual machine and improve processing efficiency of interrupt information.

According to a first aspect, an embodiment of the present disclosure provides an interrupt information processing method, applied to a central processing unit (CPU), where the CPU includes a plurality of physical central processing units (PCPUs), and one virtual central processing unit (VCPU) process of one virtual machine runs in each PCPU; and the method includes:
in response to the VCPU process switching from being in a running state to being in a wait-to-run state, obtaining interrupt attribute information corresponding to the VCPU process, where the interrupt attribute information includes interrupt type information and interrupt status information, the interrupt type information is used for indicating a type of interrupt information sent to a target PCPU where the VCPU process is located, and the interrupt status information is used for indicating whether the interrupt information can be sent to the target PCPU where the VCPU process is located;
adjusting the interrupt type information in the interrupt attribute information to preset interrupt information, and adjusting the interrupt status information in the interrupt attribute information to a receivable state, where the preset interrupt information is used for instructing the target PCPU where the VCPU process is located to execute a preset callback function, and the preset callback function is used for adjusting the VCPU process in the wait-to-run state to be in the running state; and
in response to receiving an interrupt injection instruction for the VCPU process, sending the preset interrupt information to the target PCPU where the VCPU process is located, and executing, through the target PCPU, the preset callback function associated with the preset interrupt information to adjust the VCPU process in the wait-to-run state to be in the running state.

According to a second aspect, an embodiment of the present disclosure provides an interrupt information processing apparatus, applied to a central processing unit (CPU), where the CPU includes a plurality of physical central processing units (PCPUs), and one virtual central processing unit (VCPU) process of one virtual machine runs in each PCPU; and the apparatus includes:
an obtaining module, configured to in response to the VCPU process switching from being in a running state to being in a wait-to-run state, obtain interrupt attribute information corresponding to the VCPU process, where the interrupt attribute information includes interrupt type information and interrupt status information, the interrupt type information is used for indicating a type of interrupt information sent to a target PCPU where the VCPU process is located, and the interrupt status information is used for indicating whether the interrupt information can be sent to the target PCPU where the VCPU process is located;
an adjusting module, configured to adjust the interrupt type information in the interrupt attribute information to preset interrupt information, and adjust the interrupt status information in the interrupt attribute information to a receivable state, where the preset interrupt information is used for instructing the target PCPU where the VCPU process is located to execute a preset callback function, and the preset callback function is used for adjusting the VCPU process in the wait-to-run state to be in the running state; and
a processing module, configured to in response to receiving an interrupt injection instruction for the VCPU process, send the preset interrupt information to the target PCPU where the VCPU process is located, and execute, through the target PCPU, the preset callback function associated with the preset interrupt information to adjust the VCPU process in the wait-to-run state to be in the running state.

According to a third aspect, an embodiment of the present disclosure provides an electronic device, including:
a processor, and a memory connected with the processor in a communication way;
where the memory stores computer-executable instructions; and
the processor executes the computer-executable instructions stored in the memory to implement the interrupt information processing method according to the first aspect.

According to a fourth aspect, an embodiment of the present disclosure provides a computer-readable storage medium, where the computer-readable storage medium stores computer-executable instructions which, when executed by a processor, implement the interrupt information processing method according to the first aspect.

According to a fifth aspect, an embodiment of the present disclosure provides a computer program product, including a computer program which, when executed by a processor, implements the interrupt information processing method according to the first aspect.

The interrupt information processing method and apparatus, the device, and the storage medium are provided in the embodiments. The method includes: in response to the VCPU process switching from being in the running state to being in the wait-to-run state, obtaining interrupt attribute information corresponding to the VCPU process, where the interrupt attribute information includes interrupt type information and interrupt status information; adjusting the interrupt type information in the interrupt attribute information to preset interrupt information, and adjusting the interrupt status information in the interrupt attribute information to a receivable state; and in response to receiving an interrupt injection instruction for the VCPU process, sending the preset interrupt information to a target PCPU where the VCPU process is located, and executing, through the target PCPU, a preset callback function associated with the preset interrupt information to adjust the VCPU process in the wait-to-run state to be in the running state. In the embodiments of the present disclosure, the interrupt type information corresponding to the VCPU process is first adjusted to the preset interrupt information, and the interrupt status information corresponding to the VCPU process is adjusted to the receivable state. In this way, the preset interrupt information may be sent to the target PCPU where the VCPU process is located by using an IOMMU, so that the VCPU process in the wait-to-run state is adjusted to be in the running state. Therefore, an interrupt injection delay of the VCPU process is shortened, and processing efficiency of interrupt information is improved.

### BRIEF DESCRIPTION OF DRAWINGS

In order to more clearly describe technical solutions in embodiments of the present disclosure or in the prior art, the following briefly introduces accompanying drawings used in the description of the embodiments or the prior art. Apparently, the accompanying drawings in the following description are some embodiments of the present disclosure, and persons of ordinary skill in the art can derive other accompanying drawings from these accompanying drawings without creative efforts.

FIG. 1 is a schematic diagram of an application scenario of an interrupt information processing method according to an embodiment of the present disclosure.

FIG. 2 is a flowchart of an interrupt information processing method according to an embodiment of the present disclosure.

FIG. 3 is a schematic diagram of an interrupt information processing method according to an embodiment of the present disclosure.

FIG. 4 is a schematic diagram of another interrupt information processing method according to an embodiment of the present disclosure.

FIG. 5 is a schematic diagram of another interrupt information processing method according to an embodiment of the present disclosure.

FIG. 6 is a block diagram of a structure of an interrupt information processing apparatus according to an embodiment of the present disclosure.

FIG. 7 is a schematic diagram of a hardware structure of an electronic device according to an embodiment of the present disclosure.

### DESCRIPTION OF EMBODIMENTS

In order to make objectives, technical solutions, and advantages of embodiments of the present disclosure clearer, the following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should be noted that user information (including but not limited to user device information and user personal information) and data (including but not limited to data for analysis, stored data, and displayed data) involved in the present disclosure are information and data that are authorized by users or fully authorized by all parties, and collection, use, and processing of the related data need to comply with related laws, regulations, and standards, and corresponding operation entries are provided for users to select for authorization and refusing.

In order to improve resource utilization of a CPU (Central Processing Unit), the CPU may be divided into a plurality of physical central processing units (PCPUs), and a plurality of virtual machines may be created in the CPU. Each virtual machine may be provided with a plurality of VCPU (Virtual Central Processing Unit) processes, and one virtual machine may occupy one PCPU to process a certain VCPU process in the virtual machine.

In a related art, when a certain task needs to be processed, an interrupt may be injected into a VCPU process corresponding to the task, and the task is processed by running the VCPU process. Currently, the interrupt is generally injected into the VCPU process by using an IOMMU (Input/Output Memory Management Unit), where the interrupt may be injected into the VCPU process only when the VCPU process is in a running state.

However, a VCPU process includes three states: a running state, a wait-to-run state (runnable state), and a sleep state.

If the VCPU process is in the running state, the interrupt may be directly injected into the VCPU process.

If the VCPU process is in the wait-to-run state and a VCPU thread is preempted by other process, the VCPU process needs to wait for task processing of the other process to be completed, the VCPU process can be run, and then the interrupt is injected into the VCPU process.

If the VCPU process is in the sleep state, the VCPU thread needs to be woken up first, and then the VCPU process needs to wait for task processing of the other process to be completed, and then the VCPU process is run, and the interrupt is injected into the VCPU process.

Further, in a DPU (Data Processing Unit) scenario, many processes in the CPU are offloaded to the DPU for processing. In this way, the CPU does not need to reserve a specific PCPU to process processes in the CPU, and necessary processes may be executed in any PCPU. That is, the processes in the CPU and the VCPU process may be in the same PCPU, which further increases the interrupt injection delay of the VCPU process.

It can be seen that when the VCPU process is in the wait-to-run state or the sleep state, the interrupt injection delay of the VCPU process is high, thereby reducing processing efficiency of the interrupt information. Therefore, when the VCPU process is in the wait-to-run state or the sleep state, how to reduce the interrupt injection delay of the VCPU process to improve the processing efficiency of the interrupt information is a technical problem to be solved urgently.

To solve the above problem, this embodiment provides the following technical concept: when the VCPU process is in the wait-to-run state or the sleep state, through modifying related parameters corresponding to the VCPU process, the CPU is enabled to sense that an interrupt needs to be injected into the VCPU process. In this way, when the VCPU process is in the wait-to-run state or the sleep state, an interrupt generated by a device can also be injected into the VCPU process in time, thereby reducing the interrupt injection delay.

Specific steps may include: first, in response to the VCPU process switching from being in a running state to being in a wait-to-run state, obtaining interrupt attribute information corresponding to the VCPU process, where the interrupt attribute information includes interrupt type information and interrupt status information; then, adjusting the interrupt type information in the interrupt attribute information to preset interrupt information, and adjusting the interrupt status information in the interrupt attribute information to a receivable state; and finally, in response to receiving an interrupt injection instruction for the VCPU process, sending the preset interrupt information to a target PCPU where the VCPU process is located, and executing, through the target PCPU, a preset callback function associated with the preset interrupt information to adjust the VCPU process in the wait-to-run state to be in the running state.

In this case, the interrupt type information corresponding to the VCPU process is first adjusted to the preset interrupt information, and the interrupt status information corresponding to the VCPU process is adjusted to the receivable state. In this way, the preset interrupt information may be sent to the target PCPU where the VCPU process is located by using an IOMMU, so that the VCPU process in the wait-to-run state is adjusted to be in the running state. Therefore, an interrupt injection delay of the VCPU process is shortened, and processing efficiency of interrupt information is improved.

An application scenario of the embodiments of the present disclosure is described below.

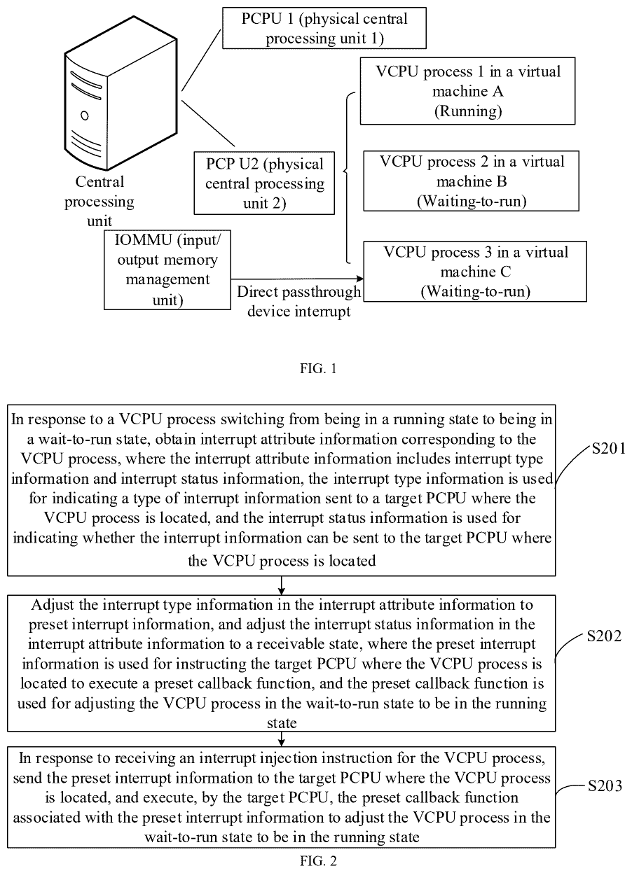

The interrupt information processing method provided in the embodiments of the present disclosure may be applied to a scenario of processing various pieces of interrupt information. For example, a scenario of processing a direct passthrough device interrupt. The direct passthrough device interrupt may be a network card interrupt, a GPU (Graphics Processing Unit) interrupt, a disk interrupt, or the like. FIG. 1 is a schematic diagram of an application scenario of an interrupt information processing method according to an embodiment of the present disclosure. A computer system shown in FIG. 1 includes a memory management unit IOMMU and a CPU, where the CPU is internally provided with a physical processor PCPU1 and a physical processor PCPU2.

One VCPU process of one virtual machine may run in each PCPU. For example, a VCPU process 1 in a virtual machine A, a VCPU process 2 in a virtual machine B, and a VCPU process 3 in a virtual machine C may run in a physical processor PCPU2. The VCPU process 1 in the virtual machine A is currently running in the PCPU2. Both the VCPU process 2 in the virtual machine B and the VCPU process 3 in the virtual machine C are in a wait-to-run state. In this case, when a direct passthrough device generates an interrupt, it is determined that the direct passthrough device interrupt corresponds to the VCPU process 3 in the virtual machine C. At this time, a direct passthrough device interrupt needs to be injected into the VCPU process 3 in the virtual machine C. By using the interrupt information processing method provided in the embodiment of the present disclosure, the VCPU process 1 is suspended, and the VCPU process 3 is adjusted to be in a running state, so that the direct passthrough device interrupt can be injected into the VCPU process 3 in the virtual machine C in time, thereby reducing an interrupt injection delay of the VCPU process and improving processing efficiency of interrupt information. The following uses detailed embodiments to describe the interrupt information processing method provided in the embodiments of the present disclosure in detail.

FIG. 2 is a flowchart of an interrupt information processing method according to an embodiment of the present disclosure. An execution subject of the interrupt information processing method may be a terminal device, and a CPU of the terminal device includes a plurality of physical processors (PCPUs); and one VCPU process of one virtual machine runs in each PCPU. As shown in FIG. 2, the method includes the following.

S201: in response to a VCPU process switching from being in a running state to being in a wait-to-run state, obtain interrupt attribute information corresponding to the VCPU process, where the interrupt attribute information includes interrupt type information and interrupt status information, the interrupt type information is used for indicating a type of interrupt information sent to a target PCPU where the VCPU process is located, and the interrupt status information is used for indicating whether the interrupt information can be sent to the target PCPU where the VCPU process is located.

In this step, one VCPU process of one virtual machine runs in each PCPU. One PCPU corresponds to one task list, and the task list includes a plurality of processes to be run. The VCPU process being in the running state indicates that the PCPU is processing the VCPU process. The VCPU process being in the wait-to-run state indicates that the VCPU process is located in a task list of the PCPU where the VCPU process is located.

In some embodiments, one VCPU process corresponds to one process identifier. The interrupt attribute information corresponding to the VCPU process may be obtained by using the process identifier corresponding to the VCPU process. Correspondingly, the obtaining the interrupt attribute information corresponding to the VCPU process includes: determining a process identifier corresponding to the VCPU process, and obtaining address information corresponding to the process identifier; and according to a first address identifier corresponding to the interrupt type information, obtaining, from the address information, the interrupt type information corresponding to the VCPU process, and according to a second address identifier corresponding to the interrupt status information, obtaining, from the address information, the interrupt status information corresponding to the VCPU process.

In an implementation, the process identifier may be a number corresponding to the VCPU process. For example, the process identifier may be a VCPU process 1, a VCPU process 2, a VCPU process 3, or the like. In an implementation, corresponding interrupt attribute information is stored in address information of each VCPU process. The address information may be represented as pi_desc.

For example, the first address identifier corresponding to the interrupt type information may be a pi_desc→nv bit, and the second address identifier corresponding to the interrupt status information may be a pi_desc→sn bit.

In an implementation, the interrupt type information may be an interrupt stored in the pi_desc→nv bit, and is used to notify the IOMMU that the type of the interrupt information sent to the target PCPU where the VCPU process is located is an interrupt type stored in the pi_desc→nv bit. For example, if an interrupt type stored in the pi_desc→nv bit is a POSTED_INTR_WAKEUP_VECTOR interrupt (type), when sending an interrupt, the IOMMU sends, to the target PCPU where the VCPU process is located, interrupt information of the type of the POSTED_INTR_WAKEUP_VECTOR interrupt. If an interrupt type stored in the pi_desc→nv bit is a POSTED_INTR_VECTOR interrupt, when sending an interrupt, the IOMMU sends, to the target PCPU where the VCPU process is located, interrupt information of the type of the POSTED_INTR_VECTOR interrupt.

In an implementation, the interrupt status information includes a receivable state and a non-receivable state. When the interrupt status information is the receivable state, the IOMMU may send interrupt information to the target PCPU where the VCPU process is located; or when the interrupt status information is the non-receivable state, the IOMMU cannot send interrupt information to the target PCPU where the VCPU process is located.

S202: adjust the interrupt type information in the interrupt attribute information to preset interrupt information, and adjust the interrupt status information in the interrupt attribute information to a receivable state, where the preset interrupt information is used for instructing the target PCPU where the VCPU process is located to execute a preset callback function, and the preset callback function is used for adjusting the VCPU process in the wait-to-run state to be in the running state.

In the embodiments of the present disclosure, when the VCPU process is in the wait-to-run state, after the device generates an interrupt, the PCPU cannot sense that an interrupt needs to be injected into the VCPU process. In this case, the PCPU first needs to be enabled to sense that an interrupt needs to be injected into the VCPU process in the wait-to-run state. Further, in order to adjust the VCPU process to be in the running state in time, preemption may be triggered to the PCPU once, so that the VCPU process is selected for execution in time.

In some embodiments, a parameter corresponding to the VCPU process may be modified, so that the PCPU is enabled to sense that an interrupt needs to be injected into the VCPU process in the wait-to-run state.

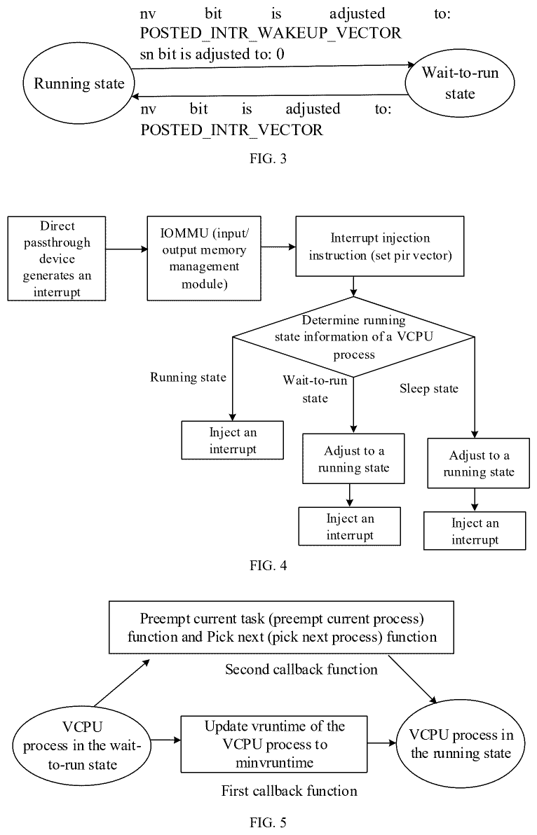

In an implementation, with reference to FIG. 3, the preset interrupt information is a POSTED_INTR_WAKEUP_VECTOR interrupt. In this way, when the VCPU process is in the wait-to-run state, the PCPU can be enabled to sense that an interrupt needs to be injected into the VCPU process in the wait-to-run state by using the interrupt. When the VCPU process is in the running state, the preset interrupt information (a POSTED_INTR_WAKEUP_VECTOR interrupt) is modified back to original interrupt information (a POSTED_INTR_VECTOR interrupt).

In an implementation, the interrupt status information includes a first preset value or a second preset value, where the first preset value indicates the receivable state, and the second preset value indicates a non-receivable state; and accordingly, the adjusting the interrupt status information in the interrupt attribute information to the receivable state includes: adjusting the interrupt status information in the interrupt attribute information to the first preset value.

For example, with continued reference to FIG. 3, the first preset value is 0, and the second preset value is 1. When the VCPU process is in the wait-to-run state, a pi_desc→sn bit corresponding to the VCPU process may be adjusted to 0. In this way, the IOMMU may send an interrupt to the target PCPU where the VCPU process is located, so that the target PCPU senses that an interrupt needs to be injected into the VCPU process in the wait-to-run state.

S203: in response to receiving an interrupt injection instruction for the VCPU process, send the preset interrupt information to the target PCPU where the VCPU process is located, and execute, through the target PCPU, the preset callback function associated with the preset interrupt information to adjust the VCPU process in the wait-to-run state to be in the running state.

In the embodiments of the present disclosure, as shown in FIG. 4, when a specific direct passthrough device of a virtual machine generates an interrupt, an interrupt needs to be injected into a corresponding VCPU process, and an interrupt injection instruction for the VCPU process is received. Since only a VCPU process in the running state can be injected with the interrupt, in the present disclosure, when receiving the interrupt injection instruction for any VCPU process, the running state of the VCPU process is first determined. The running state may be: a running state, a wait-to-run state, and a sleep state.

If the running state is the running state, the interrupt may be directly injected into the VCPU process; or if the running state is the wait-to-run state or the sleep state, the VCPU process first needs to be adjusted to be in the running state, and then the interrupt is injected into the VCPU process.

In the embodiments of the present disclosure, in order to enable the target PCPU to execute the VCPU process in time, preemption may be triggered to the target PCPU once, and the VCPU thread is selected for execution in the next scheduling. The preemption and the scheduling may be implemented by using a preset callback function.

In an implementation, the preset interrupt information is associated with the preset callback function, and when the PCPU receives the preset interrupt information, the preset callback function associated with the preset interrupt information is executed by the PCPU. Correspondingly, this step may include: sending, through the IOMMU, the preset interrupt information to the target PCPU where the VCPU process is located; and in response to the target PCPU receiving the preset interrupt information, executing, through the target PCPU, the preset callback function associated with the preset interrupt information to adjust the VCPU process in the wait-to-run state to be in the running state.

In some embodiments, a task list corresponding to the target PCPU is stored in the CPU, where the task list includes a plurality of processes to be run, and the preset callback function includes a first callback function and a second callback function. The first callback function is used for selecting a VCPU thread in the next scheduling, and the second callback function may trigger preemption to the PCPU once to suspend a current process and trigger task scheduling to run the selected VCPU thread.

Accordingly, the executing, through the target PCPU, the preset callback function associated with the preset interrupt information to adjust the VCPU process in the wait-to-run state to be in the running state includes: executing, through the target PCPU, the first callback function to adjust the VCPU process to be a first process to be run in the task list; and executing, through the target PCPU, the second callback function to suspend a currently running process in the target PCPU, and run the VCPU process to adjust the VCPU process in the wait-to-run state to be in the running state.

It should be noted that the task list further includes virtual running times respectively corresponding to the plurality of processes to be run, where the virtual running times are used for indicating priorities of the processes, and a process corresponding to a smallest virtual running time corresponds to a highest priority. Accordingly, the executing, through the target PCPU, the first callback function to adjust the VCPU process to be the first process to be run in the task list includes: executing, through the target PCPU, the first callback function to adjust a virtual running time of the VCPU process to a minimum virtual running time.

For example, as shown in FIG. 5, the virtual running time may be represented as vruntime, and the minimum virtual running time may be represented as minvruntime. The first callback function may update the vruntime of the VCPU process to the minvruntime.

In an implementation, with continued reference to FIG. 5, the second callback function includes a preempt current task function and a pick next (pick next process) function. The preempt current task function may suspend a currently running process in the target PCPU. The pick next function may trigger a scheduling opportunity, and the VCPU process is run by the target PCPU to adjust the VCPU process in the wait-to-run state to be in the running state.

It should be noted that after the VCPU process in the wait-to-run state is adjusted to be in the running state, the interrupt may be injected into the VCPU process, and a task corresponding to the interrupt is processed by the VCPU process.

The embodiment of the present disclosure provides an interrupt information processing method, including: in response to receiving an interrupt injection instruction for any VCPU process, determining a running state of the VCPU process; if the running state of the VCPU process is a wait-to-run state, obtaining interrupt attribute information corresponding to the VCPU process, where the interrupt attribute information includes interrupt type information and interrupt status information; adjusting the interrupt type information in the interrupt attribute information to preset interrupt information, and adjusting the interrupt status information in the interrupt attribute information to a receivable state; and sending, through an IOMMU, the preset interrupt information to a target PCPU where the VCPU process is located, so that the target PCPU adjusts the VCPU process in the wait-to-run state to be in a running state. In the embodiments of the present disclosure, the interrupt type information corresponding to the VCPU process is first adjusted to the preset interrupt information, and the interrupt status information corresponding to the VCPU process is adjusted to the receivable state. In this way, the preset interrupt information may be sent to the target PCPU where the VCPU process is located by using the IOMMU, so that the VCPU process in the wait-to-run state is adjusted to be in the running state. Therefore, an interrupt injection delay of the VCPU process is shortened, and processing efficiency of interrupt information is improved.

In the embodiment of the present disclosure, if the running state of the VCPU process is a sleep state, the interrupt type information in the interrupt attribute information corresponding to the VCPU process is the preset interrupt information, and the interrupt status information in the interrupt attribute information corresponding to the VCPU process is the receivable state. In this case, if the VCPU thread needs to be selected for execution in time, preemption needs to be triggered in time, and the VCPU thread is selected for execution in the next scheduling.

In an implementation, after the running state of the VCPU process is determined in response to receiving the interrupt injection instruction for any VCPU process, the method further includes:
if the running state of the VCPU process is the sleep state, sending the preset interrupt information to a PCPU where the VCPU process is located by using the IOMMU, so that the PCPU adjusts the VCPU process in the sleep state to be in the running state.

In this step, a method for adjusting the VCPU process in the sleep state to be in the running state by using the preset interrupt information is the same as a method for adjusting the VCPU process in the wait-to-run state to be in the running state by using the preset interrupt information in step S204. Details are not described herein again.

In the embodiments of the present disclosure, the preset interrupt information may be sent to the target PCPU where the VCPU process is located by using the IOMMU, so that the VCPU process in the sleep state is woken up and the VCPU process is executed in time. Therefore, an interrupt injection delay of the VCPU process in the sleep state is shortened, and processing efficiency of interrupt information is improved.

FIG. 6 is a block diagram of a structure of an interrupt information processing apparatus according to an embodiment of the present disclosure. The processing apparatus is applied to a central processing unit (CPU), where the CPU includes a plurality of physical processors (PCPUs), and one virtual processor (VCPU) process of one virtual machine runs in each PCPU. With reference to FIG. 6, the apparatus includes: an obtaining module 601, an adjusting module 602, and a processing module 603;
the obtaining module 601 is configured to in response to the VCPU process switching from being in a running state to being in a wait-to-run state, obtain interrupt attribute information corresponding to the VCPU process, where the interrupt attribute information includes interrupt type information and interrupt status information, the interrupt type information is used for indicating a type of interrupt information sent to a target PCPU where the VCPU process is located, and the interrupt status information is used for indicating whether the interrupt information can be sent to the target PCPU where the VCPU process is located;
the adjusting module 602 is configured to adjust the interrupt type information in the interrupt attribute information to preset interrupt information, and adjust the interrupt status information in the interrupt attribute information to a receivable state, where the preset interrupt information is used for instructing the target PCPU where the VCPU process is located to execute a preset callback function, and the preset callback function is used for adjusting the VCPU process in the wait-to-run state to be in the running state; and
the processing module 603 is configured to in response to receiving an interrupt injection instruction for the VCPU process, send the preset interrupt information to the target PCPU where the VCPU process is located, and execute, through the target PCPU, the preset callback function associated with the preset interrupt information to adjust the VCPU process in the wait-to-run state to be in the running state.

According to one or more embodiments of the present disclosure, the obtaining module 601, when obtaining the interrupt attribute information corresponding to the VCPU process, is specifically configured to: determine a process identifier corresponding to the VCPU process, and obtain address information corresponding to the process identifier; and according to a first address identifier corresponding to the interrupt type information, obtain, from the address information, the interrupt type information corresponding to the VCPU process, and according to a second address identifier corresponding to the interrupt status information, obtain, from the address information, the interrupt status information corresponding to the VCPU process.

According to one or more embodiments of the present disclosure, the interrupt status information includes a first preset value or a second preset value, where the first preset value indicates the receivable state, and the second preset value indicates a non-receivable state; and accordingly, the adjusting module 602, when adjusting the interrupt status information in the interrupt attribute information to the receivable state, is specifically configured to: adjust the interrupt status information in the interrupt attribute information to the first preset value.

According to one or more embodiments of the present disclosure, a task list corresponding to the target PCPU is stored in the CPU, and the task list includes a plurality of processes to be run; the preset callback function includes a first callback function and a second callback function; and accordingly, the processing module 603, when executing, through the target PCPU, the preset callback function associated with the preset interrupt information to adjust the VCPU process in the wait-to-run state to be in the running state, is specifically configured to: execute, through the target PCPU, the first callback function to adjust the VCPU process to be a first process to be run in the task list; and execute, through the target PCPU, the second callback function to suspend a currently running process in the target PCPU, and run the VCPU process to adjust the VCPU process in the wait-to-run state to be in the running state.

According to one or more embodiments of the present disclosure, the task list further includes virtual running times respectively corresponding to the plurality of processes to be run, where the virtual running times are used for indicating priorities of the processes, and a process corresponding to a smallest virtual running time corresponds to a highest priority; and accordingly, the processing module 603, when executing, through the target PCPU, the first callback function to adjust the VCPU process to be the first process to be run in the task list, is specifically configured to: execute, through the target PCPU, the first callback function to adjust a virtual running time of the VCPU process to a minimum virtual running time.

According to one or more embodiments of the present disclosure, if the VCPU process is in a sleep state, the interrupt type information in the interrupt attribute information corresponding to the VCPU process is the preset interrupt information, and the interrupt status information in the interrupt attribute information corresponding to the VCPU process is the receivable state; and accordingly, the processing module 603 is further configured to: in response to receiving an interrupt injection instruction for the VCPU process, if the VCPU process is in the sleep state, directly send the preset interrupt information to a PCPU where the VCPU process is located, such that the PCPU adjusts the VCPU process in the sleep state to be in the running state.

The obtaining module 601, the adjusting module 602, and the processing module 603 are connected in sequence. The interrupt information processing apparatus provided in this embodiment may execute the technical solution of the method embodiment above. The implementation principles and technical effects are similar, and details are not described herein again in this embodiment.

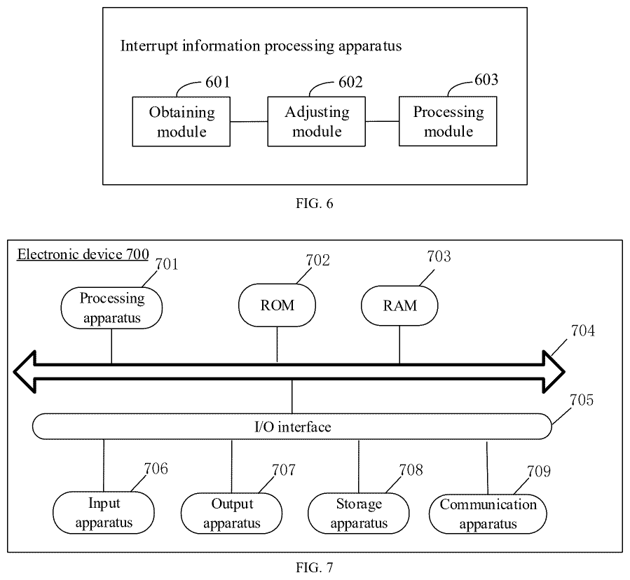

FIG. 7 is a schematic diagram of a hardware structure of an electronic device according to an embodiment of the present disclosure. With reference to FIG. 7, the electronic device 700 may be a terminal device or a server. The terminal device may include, but is not limited to, a mobile terminal such as a mobile phone, a notebook computer, a digital broadcast receiver, a personal digital assistant (PDA), a portable android device (PAD), a portable media player (PMP), and a vehicle-mounted terminal (such as a vehicle navigation terminal), and a fixed terminal such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (for example, a central processing unit, a graphics processing unit, etc.) 701, which may perform a variety of appropriate actions and processing in accordance with a program stored in a read only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all the shown apparatuses. It may be an alternative to implement or have more or fewer apparatuses.

In particular, according to an embodiment of the present disclosure, the process described above with reference to the flowcharts may be implemented as a computer software program. For example, an embodiment of the present disclosure includes a computer program product, which includes a computer program carried on a computer-readable medium, where the computer program includes a program code for performing the method shown in the flowchart. In such an embodiment, the computer program may be downloaded from a network through the communication apparatus 709 and installed, installed from the storage apparatus 708, or installed from the ROM 702. When the computer program is executed by the processing apparatus 701, the above-mentioned functions defined in the method of the embodiment of the present disclosure are executed.

It should be noted that the computer-readable medium described above in the present disclosure may be a computer-readable signal medium, or a computer-readable storage medium, or a combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, an apparatus, or a device. In the present disclosure, the computer-readable signal medium may include a data signal propagated in a baseband or as a part of a carrier, where the data signal carries a computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with the instruction execution system, the apparatus, or the device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include object-oriented programming languages such as Java, Smalltalk, and C++, and further include conventional procedural programming languages such as “C” language or similar programming languages. The program code may be completely executed in a computer of a user, partially executed in a computer of a user, executed as an independent software package, partially executed in a computer of a user and partially executed in a remote computer, or completely executed in a remote computer or server. In the case involving the remote computer, the remote computer may be connected to a computer of a user through any type of network, including a local area network (LAN) or a wide area network (WAN), or may be connected to an external computer (for example, connected through the Internet by an Internet service provider).

The flowcharts and the block diagrams in the accompanying drawings illustrate possibly implemented architecture, functions, and operations of the system, the method, and the computer program product according to various embodiments of the present disclosure. In this regard, each block in the flowchart or the block diagram may represent a module, a program segment, or part of codes, and the module, the program segment, or part of the codes contain one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software or by hardware. A name of a unit does not constitute a limitation on the unit itself in some cases. For example, a first obtaining unit may also be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with the instruction execution system, the apparatus, or the device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In a first aspect, according to one or more embodiments of the present disclosure, there is provided an interrupt information processing method, applied to a central processing unit (CPU), where the CPU includes a plurality of physical central processing units (PCPUs), and one virtual central processing unit (VCPU) process of one virtual machine runs in each PCPU; the method includes:
in response to a VCPU process switching from being in a running state to being in a wait-to-run state, obtaining interrupt attribute information corresponding to the VCPU process, where the interrupt attribute information includes interrupt type information and interrupt status information, the interrupt type information is used for indicating a type of interrupt information sent to a target PCPU where the VCPU process is located, and the interrupt status information is used for indicating whether interrupt information can be sent to the target PCPU where the VCPU process is located;
adjusting the interrupt type information in the interrupt attribute information to preset interrupt information, and adjusting the interrupt status information in the interrupt attribute information to a receivable state, where the preset interrupt information is used for instructing the target PCPU where the VCPU process is located to execute a preset callback function, and the preset callback function is used for adjusting the VCPU process in the wait-to-run state to the running state; and
in response to receiving an interrupt injection instruction for the VCPU process, sending the preset interrupt information to the target PCPU where the VCPU process is located, and executing, through the target PCPU, the preset callback function associated with the preset interrupt information to adjust the VCPU process in the wait-to-run state to the running state.

According to one or more embodiments of the present disclosure, the obtaining the interrupt attribute information corresponding to the VCPU process includes: determining a process identifier corresponding to the VCPU process, and obtaining address information corresponding to the process identifier; and according to a first address identifier corresponding to the interrupt type information, obtaining, from the address information, the interrupt type information corresponding to the VCPU process, and according to a second address identifier corresponding to the interrupt status information, obtaining, from the address information, the interrupt status information corresponding to the VCPU process.

According to one or more embodiments of the present disclosure, the interrupt status information includes a first preset value or a second preset value, where the first preset value indicates the receivable state, and the second preset value indicates a non-receivable state; and accordingly, the adjusting the interrupt status information in the interrupt attribute information to the receivable state includes: adjusting the interrupt status information in the interrupt attribute information to the first preset value.

According to one or more embodiments of the present disclosure, a task list corresponding to the target PCPU is stored in the CPU, and the task list includes a plurality of processes to be run; the preset callback function includes a first callback function and a second callback function; and accordingly, the executing, through the target PCPU, the preset callback function associated with the preset interrupt information to adjust the VCPU process in the wait-to-run state to be in the running state includes: executing, through the target PCPU, the first callback function to adjust the VCPU process to be a first process to be run in the task list; and executing, through the target PCPU, the second callback function to suspend a currently running process in the target PCPU, and run the VCPU process to adjust the VCPU process in the wait-to-run state to be in the running state.

According to one or more embodiments of the present disclosure, the task list further includes virtual running times respectively corresponding to the plurality of processes to be run, where the virtual running times are used for indicating priorities of the processes, and a process corresponding to a smallest virtual running time corresponds to a highest priority; and accordingly, the executing, through the target PCPU, the first callback function to adjust the VCPU process to be the first process to be run in the task list includes: executing, through the target PCPU, the first callback function to adjust a virtual running time of the VCPU process to a minimum virtual running time.

According to one or more embodiments of the present disclosure, if the VCPU process is in a sleep state, the interrupt type information in the interrupt attribute information corresponding to the VCPU process is the preset interrupt information, and the interrupt status information in the interrupt attribute information corresponding to the VCPU process is the receivable state; and accordingly, the method further includes: in response to receiving an interrupt injection instruction for the VCPU process, if the VCPU process is in the sleep state, directly sending the preset interrupt information to a PCPU where the VCPU process is located, such that the PCPU adjusts the VCPU process in the sleep state to be in the running state.

In a second aspect, according to one or more embodiments of the present disclosure, there is provided an interrupt information processing apparatus, applied to a central processing unit (CPU), where the CPU includes a plurality of physical central processing units (PCPUs), and one virtual central processing unit (VCPU) process of one virtual machine runs in each PCPU; the apparatus includes:
an obtaining module, configured to in response to the VCPU process switching from being in a running state to being in a wait-to-run state, obtain interrupt attribute information corresponding to the VCPU process, where the interrupt attribute information includes interrupt type information and interrupt status information, the interrupt type information is used for indicating a type of interrupt information sent to a target PCPU where the VCPU process is located, and the interrupt status information is used for indicating whether the interrupt information can be sent to the target PCPU where the VCPU process is located;
an adjusting module, configured to adjust the interrupt type information in the interrupt attribute information to preset interrupt information, and adjust the interrupt status information in the interrupt attribute information to a receivable state, where the preset interrupt information is used for instructing the target PCPU where the VCPU process is located to execute a preset callback function, and the preset callback function is used for adjusting the VCPU process in the wait-to-run state to be in the running state; and
a processing module, configured to in response to receiving an interrupt injection instruction for the VCPU process, send the preset interrupt information to the target PCPU where the VCPU process is located, and execute, through the target PCPU, the preset callback function associated with the preset interrupt information to adjust the VCPU process in the wait-to-run state to be in the running state.

According to one or more embodiments of the present disclosure, the obtaining module, when obtaining the interrupt attribute information corresponding to the VCPU process, is specifically configured to: determine a process identifier corresponding to the VCPU process, and obtain address information corresponding to the process identifier; and according to a first address identifier corresponding to the interrupt type information, obtain, from the address information, the interrupt type information corresponding to the VCPU process, and according to a second address identifier corresponding to the interrupt status information, obtain, from the address information, the interrupt status information corresponding to the VCPU process.

According to one or more embodiments of the present disclosure, the interrupt status information includes a first preset value or a second preset value, where the first preset value indicates the receivable state, and the second preset value indicates a non-receivable state; and accordingly, the adjusting module, when adjusting the interrupt status information in the interrupt attribute information to the receivable state, is specifically configured to: adjust the interrupt status information in the interrupt attribute information to the first preset value.

According to one or more embodiments of the present disclosure, a task list corresponding to the target PCPU is stored in the CPU, and the task list includes a plurality of processes to be run; the preset callback function includes a first callback function and a second callback function; and accordingly, the processing module, when executing, through the target PCPU, the preset callback function associated with the preset interrupt information to adjust the VCPU process in the wait-to-run state to be in the running state, is specifically configured to: execute, through the target PCPU, the first callback function to adjust the VCPU process to be a first process to be run in the task list; and execute, through the target PCPU, the second callback function to suspend a currently running process in the target PCPU, and run the VCPU process to adjust the VCPU process in the wait-to-run state to be in the running state.

According to one or more embodiments of the present disclosure, the task list further includes virtual running times respectively corresponding to the plurality of processes to be run, where the virtual running times are used for indicating priorities of the processes, and a process corresponding to a smallest virtual running time corresponds to a highest priority; and accordingly, the processing module, when executing, through the target PCPU, the first callback function to adjust the VCPU process to be the first process to be run in the task list, is specifically configured to: execute, through the target PCPU, the first callback function to adjust a virtual running time of the VCPU process to a minimum virtual running time.

According to one or more embodiments of the present disclosure, if the VCPU process is in a sleep state, the interrupt type information in the interrupt attribute information corresponding to the VCPU process is the preset interrupt information, and the interrupt status information in the interrupt attribute information corresponding to the VCPU process is the receivable state; and accordingly, the processing module is further configured to: in response to receiving an interrupt injection instruction for the VCPU process, if the VCPU process is in the sleep state, directly send the preset interrupt information to a PCPU where the VCPU process is located, such that the PCPU adjusts the VCPU process in the sleep state to be in the running state.

In a third aspect, according to one or more embodiments of the present disclosure, there is provided an electronic device, including: a processor, and a memory connected with the processor in a communication way;
the memory stores computer-executable instructions; and
the processor executes the computer-executable instructions stored in the memory to implement the interrupt information processing method described above in the first aspect and various possible designs of the first aspect.

In a fourth aspect, according to one or more embodiments of the present disclosure, there is provided a computer-readable storage medium having stored therein computer-executable instructions which, when executed by a processor, implement the interrupt information processing method described above in the first aspect and various possible designs of the first aspect.

In a fifth aspect, according to one or more embodiments of the present disclosure, there is provided a computer program product, including a computer program which, when executed by a processor, implements the interrupt information processing method described above in the first aspect and various possible designs of the first aspect.

The foregoing descriptions are merely preferred embodiments of the present disclosure and explanations of the applied technical principles. Persons skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure, for example, a technical solution formed by replacing the foregoing features with technical features having similar functions disclosed in the present disclosure (but not limited thereto).

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are contained in the foregoing discussions, these details should not be construed as limiting the scope of the present disclosure. Certain features that are described in the context of separate embodiments may alternatively be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms for implementing the claims.

What is claimed is:

1. An interrupt information processing method, applied to a central processing unit (CPU), wherein the CPU comprises a plurality of physical central processing units (PCPUs), and one virtual central processing unit (VCPU) process of one virtual machine runs in each PCPU; and the method comprises:
in response to the VCPU process switching from being in a running state to being in a wait-to-run state, obtaining interrupt attribute information corresponding to the VCPU process, wherein the interrupt attribute information comprises interrupt type information and interrupt status information, the interrupt type information is used for indicating a type of interrupt information sent to a target PCPU where the VCPU process is located, and the interrupt status information is used for indicating whether the interrupt information can be sent to the target PCPU where the VCPU process is located;
adjusting the interrupt type information in the interrupt attribute information to preset interrupt information, and adjusting the interrupt status information in the interrupt attribute information to a receivable state, wherein the preset interrupt information is used for instructing the target PCPU where the VCPU process is located to execute a preset callback function, and the preset callback function is used for adjusting the VCPU process in the wait-to-run state to be in the running state;
in response to receiving an interrupt injection instruction for the VCPU process, sending the preset interrupt information to the target PCPU where the VCPU process is located, and executing, through the target PCPU, the preset callback function associated with the preset interrupt information to adjust the VCPU process in the wait-to-run state to be in the running state.

2. The method according to claim 1, wherein the obtaining the interrupt attribute information corresponding to the VCPU process comprises:
determining a process identifier corresponding to the VCPU process, and obtaining address information corresponding to the process identifier;
according to a first address identifier corresponding to the interrupt type information, obtaining, from the address information, the interrupt type information corresponding to the VCPU process, and according to a second address identifier corresponding to the interrupt status information, obtaining, from the address information, the interrupt status information corresponding to the VCPU process.

3. The method according to claim 1, wherein the interrupt status information comprises a first preset value or a second preset value, the first preset value indicates the receivable state, and the second preset value indicates a non-receivable state;
accordingly, the adjusting the interrupt status information in the interrupt attribute information to the receivable state comprises:
adjusting the interrupt status information in the interrupt attribute information to the first preset value.

4. The method according to claim 1, wherein a task list corresponding to the target PCPU is stored in the CPU, the task list comprises a plurality of processes to be run, and the preset callback function comprises a first callback function and a second callback function;
accordingly, the executing, through the target PCPU, the preset callback function associated with the preset interrupt information to adjust the VCPU process in the wait-to-run state to be in the running state comprises:
executing, through the target PCPU, the first callback function to adjust the VCPU process to be a first process to be run in the task list;
executing, through the target PCPU, the second callback function to suspend a currently running process in the target PCPU, and run the VCPU process to adjust the VCPU process in the wait-to-run state to be in the running state.

5. The method according to claim 4, wherein the task list further comprises virtual running times respectively corresponding to the plurality of processes to be run, the virtual running times are used for indicating priorities of the processes, and a process corresponding to a smallest virtual running time corresponds to a highest priority;
accordingly, the executing, through the target PCPU, the first callback function to adjust the VCPU process to be the first process to be run in the task list comprises:
executing, through the target PCPU, the first callback function to adjust a virtual running time of the VCPU process to a minimum virtual running time.

6. The method according to claim 1, wherein when the VCPU process is in a sleep state, the interrupt type information in the interrupt attribute information corresponding to the VCPU process is the preset interrupt information, and the interrupt status information in the interrupt attribute information corresponding to the VCPU process is the receivable state; and accordingly, the method further comprises:
in response to receiving an interrupt injection instruction for the VCPU process, when the VCPU process is in the sleep state, directly sending the preset interrupt information to a PCPU where the VCPU process is located, such that the PCPU adjusts the VCPU process in the sleep state to be in the running state.

7. The method according to claim 2, wherein when the VCPU process is in a sleep state, the interrupt type information in the interrupt attribute information corresponding to the VCPU process is the preset interrupt information, and the interrupt status information in the interrupt attribute information corresponding to the VCPU process is the receivable state; and accordingly, the method further comprises:
in response to receiving an interrupt injection instruction for the VCPU process, when the VCPU process is in the sleep state, directly sending the preset interrupt information to a PCPU where the VCPU process is located, such that the PCPU adjusts the VCPU process in the sleep state to be in the running state.

8. The method according to claim 3, wherein when the VCPU process is in a sleep state, the interrupt type information in the interrupt attribute information corresponding to the VCPU process is the preset interrupt information, and the interrupt status information in the interrupt attribute information corresponding to the VCPU process is the receivable state; and accordingly, the method further comprises:
in response to receiving an interrupt injection instruction for the VCPU process, when the VCPU process is in the sleep state, directly sending the preset interrupt information to a PCPU where the VCPU process is located, such that the PCPU adjusts the VCPU process in the sleep state to be in the running state.

9. An interrupt information processing apparatus, applied to a central processing unit (CPU), wherein the CPU comprises a plurality of physical central processing units (PCPUs), and one virtual central processing unit (VCPU) process of one virtual machine runs in each PCPU; and the apparatus comprises:
a processor, and a memory connected with the processor in a communication way;
wherein the memory stores computer-executable instructions;
the computer-executable instructions, when executed by the processor, cause the processor to:
in response to the VCPU process switching from being in a running state to being in a wait-to-run state, obtain interrupt attribute information corresponding to the VCPU process, wherein the interrupt attribute information comprises interrupt type information and interrupt status information, the interrupt type information is used for indicating a type of interrupt information sent to a target PCPU where the VCPU process is located, and the interrupt status information is used for indicating whether the interrupt information can be sent to the target PCPU where the VCPU process is located;
adjust the interrupt type information in the interrupt attribute information to preset interrupt information, and adjust the interrupt status information in the interrupt attribute information to a receivable state, wherein the preset interrupt information is used for instructing the target PCPU where the VCPU process is located to execute a preset callback function, and the preset callback function is used for adjusting the VCPU process in the wait-to-run state to be in the running state;
in response to receiving an interrupt injection instruction for the VCPU process, send the preset interrupt information to the target PCPU where the VCPU process is located, and execute, through the target PCPU, the preset callback function associated with the preset interrupt information to adjust the VCPU process in the wait-to-run state to be in the running state.

10. The apparatus according to claim 9, wherein when obtaining the interrupt attribute information corresponding to the VCPU process, the processor is specifically caused to:
determine a process identifier corresponding to the VCPU process, and obtain address information corresponding to the process identifier;
according to a first address identifier corresponding to the interrupt type information, obtain, from the address information, the interrupt type information corresponding to the VCPU process, and according to a second address identifier corresponding to the interrupt status information, obtain, from the address information, the interrupt status information corresponding to the VCPU process.

11. The apparatus according to claim 9, wherein the interrupt status information comprises a first preset value or a second preset value, the first preset value indicates the receivable state, and the second preset value indicates a non-receivable state;
when adjusting the interrupt status information in the interrupt attribute information to the receivable state, the processor is specifically caused to:
adjust the interrupt status information in the interrupt attribute information to the first preset value.

12. The apparatus according to claim 9, wherein a task list corresponding to the target PCPU is stored in the CPU, the task list comprises a plurality of processes to be run, and the preset callback function comprises a first callback function and a second callback function;
when executing, through the target PCPU, the preset callback function associated with the preset interrupt information to adjust the VCPU process in the wait-to-run state to be in the running state, the processor is specifically caused to:
execute, through the target PCPU, the first callback function to adjust the VCPU process to be a first process to be run in the task list;
execute, through the target PCPU, the second callback function to suspend a currently running process in the target PCPU, and run the VCPU process to adjust the VCPU process in the wait-to-run state to be in the running state.

13. The apparatus according to claim 12, wherein the task list further comprises virtual running times respectively corresponding to the plurality of processes to be run, the virtual running times are used for indicating priorities of the processes, and a process corresponding to a smallest virtual running time corresponds to a highest priority;
when executing, through the target PCPU, the first callback function to adjust the VCPU process to be the first process to be run in the task list, the processor is specifically caused to:
execute, through the target PCPU, the first callback function to adjust a virtual running time of the VCPU process to a minimum virtual running time.

14. The apparatus according to claim 9, wherein when the VCPU process is in a sleep state, the interrupt type information in the interrupt attribute information corresponding to the VCPU process is the preset interrupt information, and the interrupt status information in the interrupt attribute information corresponding to the VCPU process is the receivable state; and the processor is further caused to:
in response to receiving an interrupt injection instruction for the VCPU process, when the VCPU process is in the sleep state, directly send the preset interrupt information to a PCPU where the VCPU process is located, such that the PCPU adjusts the VCPU process in the sleep state to be in the running state.

15. A non-transitory computer-readable storage medium, storing computer-executable instructions which, when executed by a processor, cause the processor to implement the following:
in response to a virtual central processing unit (VCPU) process switching from being in a running state to being in a wait-to-run state, obtaining interrupt attribute information corresponding to the VCPU process, wherein the interrupt attribute information comprises interrupt type information and interrupt status information, the interrupt type information is used for indicating a type of interrupt information sent to a target physical central processing unit (PCPU) where the VCPU process is located, and the interrupt status information is used for indicating whether the interrupt information can be sent to the target PCPU where the VCPU process is located, wherein one VCPU process of one virtual machine runs in each PCPU;
adjusting the interrupt type information in the interrupt attribute information to preset interrupt information, and adjusting the interrupt status information in the interrupt attribute information to a receivable state, wherein the preset interrupt information is used for instructing the target PCPU where the VCPU process is located to execute a preset callback function, and the preset callback function is used for adjusting the VCPU process in the wait-to-run state to be in the running state;
in response to receiving an interrupt injection instruction for the VCPU process, sending the preset interrupt information to the target PCPU where the VCPU process is located, and executing, through the target PCPU, the preset callback function associated with the preset interrupt information to adjust the VCPU process in the wait-to-run state to be in the running state.

16. The storage medium according to claim 15, wherein when obtaining the interrupt attribute information corresponding to the VCPU process, the processor is specifically caused to implement the following:
determining a process identifier corresponding to the VCPU process, and obtaining address information corresponding to the process identifier;
according to a first address identifier corresponding to the interrupt type information, obtaining, from the address information, the interrupt type information corresponding to the VCPU process, and according to a second address identifier corresponding to the interrupt status information, obtaining, from the address information, the interrupt status information corresponding to the VCPU process.

17. The storage medium according to claim 15, wherein the interrupt status information comprises a first preset value or a second preset value, the first preset value indicates the receivable state, and the second preset value indicates a non-receivable state;
when adjusting the interrupt status information in the interrupt attribute information to the receivable state, the processor is specifically caused to implement the following:
adjusting the interrupt status information in the interrupt attribute information to the first preset value.

18. The storage medium according to claim 15, wherein a task list corresponding to the target PCPU is stored in the CPU, the task list comprises a plurality of processes to be run, and the preset callback function comprises a first callback function and a second callback function;
when executing, through the target PCPU, the preset callback function associated with the preset interrupt information to adjust the VCPU process in the wait-to-run state to be in the running state, the processor is specifically caused to implement the following:
executing, through the target PCPU, the first callback function to adjust the VCPU process to be a first process to be run in the task list;
executing, through the target PCPU, the second callback function to suspend a currently running process in the target PCPU, and run the VCPU process to adjust the VCPU process in the wait-to-run state to be in the running state.

19. The storage medium according to claim 18, wherein the task list further comprises virtual running times respectively corresponding to the plurality of processes to be run, the virtual running times are used for indicating priorities of the processes, and a process corresponding to a smallest virtual running time corresponds to a highest priority;
when executing, through the target PCPU, the first callback function to adjust the VCPU process to be the first process to be run in the task list, the processor is specifically caused to implement the following:
executing, through the target PCPU, the first callback function to adjust a virtual running time of the VCPU process to a minimum virtual running time.

20. The storage medium according to claim 15, wherein when the VCPU process is in a sleep state, the interrupt type information in the interrupt attribute information corresponding to the VCPU process is the preset interrupt information, and the interrupt status information in the interrupt attribute information corresponding to the VCPU process is the receivable state; and the processor is further caused to implement the following:
in response to receiving an interrupt injection instruction for the VCPU process, when the VCPU process is in the sleep state, directly sending the preset interrupt information to a PCPU where the VCPU process is located, such that the PCPU adjusts the VCPU process in the sleep state to be in the running state.
